(19) United States
(12) Patent Application Publication
(10) Pub. No.: US 2020/0192950 A1
(43) Pub. Date: Jun. 18, 2020

(54) System for searching web-based content data using gaming

(71) Applicants: Chris Trahan, San Jose, CA (US); Ryan Trahan, San Jose, CA (US); David Olszewski, Campbell, CA (US)

(72) Inventors: Chris Trahan, San Jose, CA (US); Ryan Trahan, San Jose, CA (US); David Olszewski, Campbell, CA (US)

(21) Appl. No.: 16/602,794

(22) Filed: Dec. 4, 2019

Related U.S. Application Data
(62) Division of application No. 62/917,616, filed on Dec. 18, 2018.

(51) Int. Cl. G06F 16/9532; A63F 13/80

(52) U.S. Cl. CPC G06F 16/9532; A63F 13/80

(57) ABSTRACT

The unique web-based gamification process where opt-in feature and is designed to encourage engagement of searching individuals or entities to view more websites, through a contest or game. Searching entities receive clues that will help to guide them to begin a search directed to a determined end search result or target search. Through an iterative process, searching entity receive additional clues and/or indicators until the searching entity reaches the determined end search result or target search, wherein the searching individual or entity receives or wins the reward or the prize.

### RELATED APPLICATION

This patent application claims priority under 35 U.S.C. 119 (e) of the co-pending U.S. Provisional Patent Application Ser. No. 62/917,616, filed Dec. 18, 2018, and titled “SYSTEM FOR SEARCHING WEB-BASED CONTENT DATA USING GAMING.” The co-pending U.S. Provisional Patent Application Ser. No. 62/917,616, filed Dec. 18, 2018, and titled “SYSTEM FOR SEARCHING WEB-BASED CONTENT DATA USING GAMING” is hereby incorporated by reference.

### FIELD OF THE INVENTION

This invention relates to computer systems for managing web-based content data in a cloud-based computing environment. More particularly, the present invention relates to computer systems for managing web-based content data in a cloud-based computing environment chronologically.

### BACKGROUND OF THE INVENTION

Cloud-based computing provides computation, software, data access, and storage services that do not require a user to have knowledge of the physical location and configuration of the system and architecture that delivers the content data and/or services. Cloud-based computing can include the delivery of any kind of content data and/or services in real-time, which extend the capabilities to a remote computing device, typically over the internet.

There are a number of computer systems that manage web-based content data chronologically. For example, e-mail servers and host computer e-mail programs allow users to organize e-mails according to the date or time that the e-mail communications are transmitted, the subject threads of the e-mail communications, the file sizes of the e-mail communications and the originators of the e-mail communications.

In the U.S. Pat. No. 7,725,492, to Sittig et al., a system is disclosed that allow users to organize relationships in a social network via a social time line. Sittig et al. describe a system, whereby data with calendar dates are received between multiple user's. The data is then organized in chronological order and photos are coupled to the data corresponding the multiple users, thereby generating a social time-line.

In U.S. Pat. No. 7,802,007 to Reese, a methods and apparatus for facilitating consumption of services via a services network are described. In the system of Reese, access is provided to a services directory which identifies a plurality of services and at least one connector for facilitating consumption of each of the services via the network. Each connector is operable to mediate communication protocol and business policy differences between a first network end point associated with the corresponding service and a second network end point associated with a consumer of the service. For each of selected ones of the connectors, information accessible via the services directory is provided regarding how to use the connector to consume the corresponding service. For each of selected ones of the services, access to a connector design process is provided via the services directory. The connector design process is operable to facilitate creation of a new connector for the corresponding service, and to specify at least one business process for mediating the business policy differences.

In the U.S. Pat. No. 7,788,399, Brouk et al. describe a system and method for enabling the interchange of enterprise data through an open platform. In the system of Brouk et al. the open platform can be based on a standardized interface that enables parties to easily connect to and use the network. Services operating as senders, recipients, and in-transit parties can, therefore, leverage a framework that overlays a public network.

### SUMMARY OF THE INVENTION

The present invention is directed to a computer implemented system for organizing content data chronologically. The system preferably operates in a cloud-based networking environment. The system includes a server that is accessible over the internet/Intranet from remote computer devices through a network, such as the internet. Application software runs on the server that is configured to host any number data services, such as e-mail. The application software is configured to directly run an e-mail application or alternatively is configured to interface with an external e-mail application or any other electronic communications application, such as social network applications.

Preferably, the application software is coded for organizing electronic communications data from multiple content sources or users. The application software is configured to organize the electronic communications chronologically into time-lines. The time-lines are viewable from remote computer devices on a single graphical user interface that is preferably an icon-based graphical user interface.

The time-lines represent, for example, a potential business transaction between two business entities. The time-lines are coded with dates that are accessible sub-files. The sub-files contain electronic communications data between the multiple content sources (users) from the entities, which have been transmitted on dates along the time-lines. Preferably, each of the sub-files are coded or configured to be coded for a level of success and numeric indicating a number of transmissions of electronic communication data that have occurred between the multiple content sources (users) on the dates corresponding to each of the sub-files.

In further embodiments of the invention the application software is coded for organizing electronic communications data or sub-files from the time-lines into a folder according to a metric, such as the level of success assigned by a user. The software for organizing electronic communications data or sub-files from the time-lines into a folder according to the metric is preferably operated through a tool feature on the graphical user interface that is operable by the user from remote computer devices.

The application software in yet further embodiments of the invention includes e-mail hosting software. In operation the application software is configured extracted the electronic communications data from the multiple content sources (e-mail accounts) to generate the time-lines based on user identifiers associated business entity or entities and/or transaction identifier that corresponds to the time-line.

The time-lines or portions thereof can be tagged to be accessible by multiple users in a social network environment over the internet, such that some of the electronic communications data is shared by authorized users through remote computer devices.

In accordance with the method of the present invention, transactions from multiple content sources are manages through the graphical user interface by establishing a relationship identity or identifier that defines a time-line. The relationship identity or identifier includes, for example, a name of company and any number of selected content sources, users and/or e-mail accounts corresponding to, or associated with, the name, the relationship identity or the identifier. The server receives electronic communications data from two or more of the content sources and the application software organizing the electronic communications data into sub-files based on dates the electronic communications data was transmitted (sent or received). The application software then displays the sub-files on a time-line corresponding to the name, the relationship identity or the identifier the through the graphical user interface.

As described above, the application software preferably includes tools that allow users to code the sub-files according to a metric, such as a success metric. For example the sub-files are coded with a color to indicates a level of success. The sub-files are also coded with a numeric to indicate a number of communications contained within each sub-file. The graphical user interface also preferably includes tool features that allow users to organizing the sub-files into a folder according to the metric. The server and application software in further embodiments of the invention is configured to store user history analytics based the electronic communications data transmitted and/or remote computer usage.

In addition to the features described above, the system of the present invention includes a tool that allows a user to post goods and/or services that the user's business is interested in; similar to posting a “wanted” add electronically. Thus, regardless of any level of success, or lack thereof, the user is still broadcasting the needs of his or her organization or company.

In summary the present invention provide tools and/or platforms for individuals or entities and business to engage across a single platform. The tools and/or platforms allows individuals or entities and business to communicate about products and services between registered individuals or entities to provide discounts services or products, share reviews or services or products and share such information, and any other information, within a social media type of environment. The tools and/or platforms utilize a number of services, such as Facebook, LinkedIn and Amazon, e-mail, which can be deployed from any server infrastructure through a website, set-top box, mobile applications, on web enabled devices with or without screens.

In operation a search tool allows registered individuals or entities to search account information and/or web information data contained within a data base that contains the account information and/or web information data of individuals, entities or businesses that provide the goods or services. Two aspects of the search tool are described below.

The search tool of the present invention preferably utilize a search algorithm that integrates search terms across profiles of geolocation based individuals, entities or businesses, discounted products and services of any combination thereof. In addition the search tool allows searching individuals or entities to save the search results to their favorites, share those search results with friends and family or email them to other there individuals, entities or businesses within the platform data base. The message system of the platform enables integration of search data and users profiles so that searching individuals, entities or businesses are able to send text messages, pictures and videos to third-party blog walls within or outside of the platform data base.

In addition to the search algorithm and the inter and intra-communication features described above the platform of the present invention allows individuals, entities and business sign-up for and setup a unique gamification process a “search game” as outlined in the block-flow diagram 500 shown in FIG. 5. The unique gamification process is preferably and opt-in feature and is designed to encourage engagement of searching individuals or entities to view more websites, other registered individuals, entities or businesses and related services or products through a contest or game. During the contest or game, searching individuals or entities will opt-in to the contest or game. When searching individuals or entities opt-in to the contest or game they will receive clue that will help to guide them to begin a search directed to a determined end search result or target search. Clues are, but not limited to, words, phases, sounds, pictures and video that represent a subject, a category, an activity, a place, a person or any combination thereof. Clues that are provided to searching individual or entity can be determined or selected using information related previous activity or searches (history analytics) within the program or search tools and/or information within the profile of the searching individual or entity. After the searching individual or entity is provide the clue, the searching individual or entity then uses that clues to help direct or guide a first search within the data base to in an attempt to reach a determined end search result or target search. Within the gaming mode, the search game is set up by a sponsor in the platform, which is generally an individual, a entity or a business that is registered in the data base of the platform that other individuals, entities or a businesses can participate within by the opt-in process described above, hereafter referred to as a searching individual or entity. When the searching individual or entity reaches the determined end search result or target search, the searching individual or entity is issued or given a reward or a prize.

As described previously, the data base includes information of individuals, entities or businesses that engage in commerce to provide services or goods. After the first search using the first clue provided, the searching individual or entity is give a second clue to further direct or guide a second search towards a determined end search result or target search. The iterative process of receiving clues and preforming informed, guided or directed searches using clues is repeated until the searching entity or individual reaches the determined end search result or target search, wherein the searching individual or entity receives or wins the reward or the prize. The determined end search result or target search is, for example, a selected website, a service or product page and the reward or the prize can include, for example, a coupon, a free or discounted product or service, a cash prize or any other benefit. The reward or prize can be related directly to the determined end search result or target search, a related service or product searched or another service or product to be promoted.

As another aspect or feature of participation within the gaming mode of the searching platform is that as the searching individual or entity preforms searching iterations, the searching individual or entity is provided an indicator that shows that the interactive searches are advancing toward determined end search result or target search or farther away for the determined end search result or target search. The indicator is similar to what has been previously referred to a success metric. In the gamming mode the success metric is an icon or symbol or sound. For example, the success metric is a thumb up or thumbs down, a green light and a red light, a hot and cold symbol or any other suitable simple or complex arrangement of indicators (signal, signs and or symbols) that provide and indication to the searching individual or entity that the iterative searches are leading to the determined end search result or target search or moving away from the determined end search result or target search. For example, the success metric is a dial, linear fill-in bar, a numeric display, to name a few. The success metric also be an audio signal alone or in addition to a visual or graphic indicator, such as the visual indicators described above.

The following example of the operation of the gaming mode within the searching platform is described for illustrative purposes and it will be clear to one skilled in the art that game can be incorporate any number or features and combination of features (indicators or success metrics and rewards or prizes) such as described above. To begin the game, the searching individual or entity signs up and opts-in to the game, which has been described in detail above. After the searching individual or entity agrees to participate in the game, the searching individual or entity is issued a first clue. The game itself was, for example, is initiated or set-up through an application tool by a swimming equipment company, or a systems administrator for swimming equipment company, that sells swim goggles and the reward or prize is a free pair of swim goggles.

In this example the searching individual or entity is provided a text clue for the word “water.” The searching individual or entity searches using the phase “swimming pool equipment.” with or without the word water. The searching platform recognizing that this is a reasonably close search to the determined end search result or target search and issues an indicator or success metric such as “hot” signal, sign or symbol to indicates that the search is leading toward the determined end search result or target search. The searching platform then issues a second clue, such as a text clue for the word “visibility.” In a second search iteration, the searching individual or entity may, for example, searches for water purifier. The searching platform recognizing that this search is farther form the determined end search result or target search than the first search and system issues an indicator or success metric such as “cold” signal, sign or symbol to indicates that the search is going in the wrong direction or away fonn the determined end search result or target search. In yet another search iteration, the searching individual or entity may, for example, searches for “water swimming gear.” The searching platform recognizing that this search is closer to the determined end search result or target search and system issues an indicator or success metric such as “hot” signal, sign or symbol that indicates that the search is going getting closer to the determined end search result or target search. After any number or search iteration using any number of clues provides and provides any number of indicator or success metric, the searching individual or entity eventually searches the data base using the term “swim goggle” and reaches the determined end search result or target search and receives the reward or the prize; in this case a free pair or swim goggles or ability to acquire a free pair of goggles through, for example, a coupon.

The present invention, in addition to advancing relationships in business and commence through ranking and monitoring progress, the present invention seeks engage searching individuals and entities to search through a search algorithm and data base and through gamming techniques, coined “gamification.” The gaming aspect of the present invention helps to promote searching and exploration of services and products represented by businesses or individuals registered within the data base.

### BRIEF DESCRIPTION OF THE DRAWINGS

FIG. 1 is a schematic representation of a cloud-based computer system for managing electronic communications data from multiple sources, in accordance with the embodiments of the invention.

FIG. 2A shows a representation of a time-line with chronologically displayed sub-file containing electronic communications data between the multiple sources entities corresponding to dates of transmission, in accordance with the embodiments of the invention.

FIG. 2B shows a tool feature for coding and displayed sub-files containing electronic communications data between the multiple sources entities based on a metric, in accordance with the embodiments of the invention.

FIG. 3A shows dynamic user page with multiple displayable and interactive time-lines, in accordance with the embodiments of the invention.

FIG. 3B shows a tool feature for coding and organizing electronic communications data or sub-files from time-lines into a folder based on a metric, in accordance with the embodiments of the invention.

FIG. 4 shows a block-flow diagram outlining steps of a method for managing transactions from multiple content sources through a graphical user interface, in accordance with the embodiments of the invention.

FIG. 5 shows a block-flow diagram outlining steps of a method for searching we-based content data using gaming, in accordance with the embodiments of the invention.

### DETAILED DESCRIPTION OF THE INVENTION

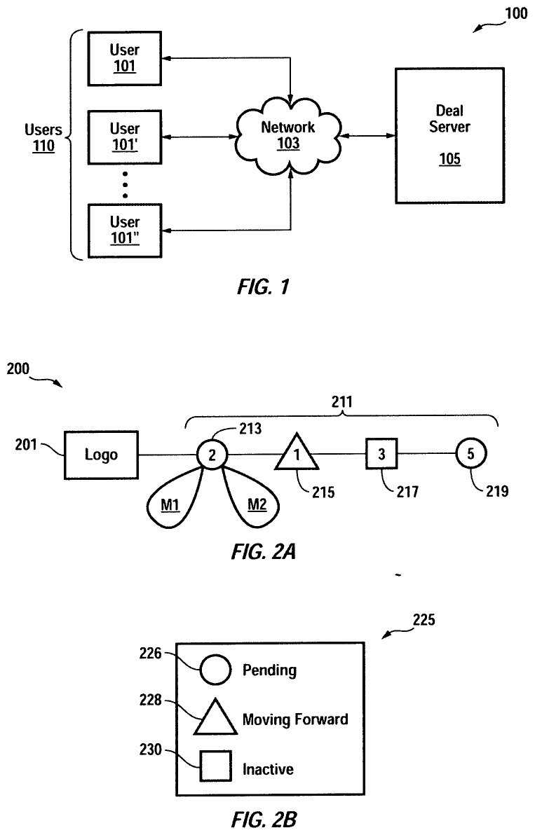

FIG. 1 is a schematic representation of a computer implemented system 100 for managing electronic communications data from multiple sources or users 101, 101′ and 101″, collectively 100. The system 100 preferably operates in a cloud-based networking environment and includes a server 105 that is accessible over the internet/Intranet from remote computer devices through a network 103, such as the internet. Application software runs on the server 105 that is configured to host any number data services, such as e-mail. The application software is configured to directly run an e-mail application or alternatively is configured to interface with an external e-mail application or any other electronic communications application, such as a social network applications.

The application software is coded for organizing electronic communications data from multiple content sources or users 110 chronologically. Electronic communications data includes any data or information that is transmitted between internet/intranet enabled devices. The multiple content sources or users 110 include remote computers and users as well as other servers that operate over the network 103 including, but not limited to, e-mail servers and social network servers.

The application software of the present invention is configured to organize the electronic communications chronologically into time-lines, such as shown in FIG. 2A. The time-lines are viewable from the remote computer devices on a single graphical user interface. The graphical user interface is preferably an icon-based graphical user interface.

Referring to FIG. 2A, a time-line 200 in accordance with the embodiments the invention is displayable and interactive. The time-line 200 of the present invention is preferably chronological display of electronic communications data between multiple content sources or users from two entities that are establishing a relationship. Accordingly, the time-line 200 is preferably labeled with an identifier or name 201 that indicates or identifies an entity that an end user, a hosting company or account owner is attempting to establish a relationship with. The identifier or name 201 is, for example, a company log.

In operation, multiple content sources or users U1 and U2 within the two entities transmit and receive electronic communications data through, for example, an e-mail application running on the server 105 or another server. The application software interfaces with the e-mail application and organizes the electronic communications data transmitted into sub-files 213, 215, 217 and 219, collectively 211. The sub-files 211 are chronologically displayed according to the dates D1, D2, D3 and D4 of transmission of the electronic communications data.

Each of the sub-files 211 are accessible and configured to be opened from the graphical user interface, such that the electronic communication data contained therein can be reviewed or retrieved. For example, the sub-file 213 contains two (2) transmissions of electronic communication data M1 and M2. The end user, hosting company or account owner of the time-line 200 can select the sub-file 213 and view, copy, resent or edit the transmissions of electronic communication data M1 and M2. Preferably, each of the sub-files is labeled with a numeric indicating the number of transmissions of electronic communication data that have occurred between the multiple content sources (users) U1 and U2 on the dates corresponding to each of the sub-files 211. For example, sub-files 215 contains (1) transmissions of electronic communication data, sub-files 217 contains three (3) transmissions of electronic communication data, sub-files 219 contains five (5) transmissions of electronic communication data and so on.

In further embodiments of the invention, the application software host one or more tool features 225. A tool feature is usually represent by an icon, that are viewable and/or selectable from a from a computing device; selecting the tool will generally initiate one or more software sequences to access, display and/or organize electronic communications data on a graphical user interface on a computer devices.

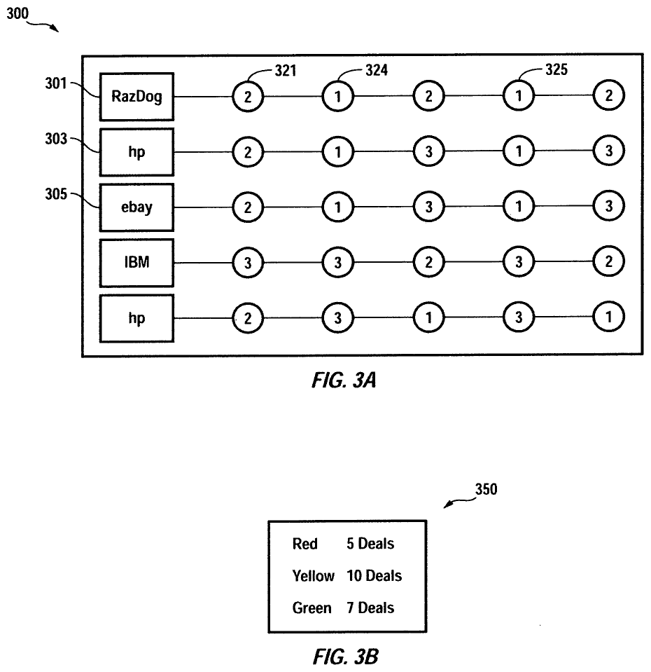

The tool feature 225 allows the end user, hosting company or account owner of the time-line 200 to code the time-line, electronic communications data and or sub-files 211 with a metric. For example, the sub-file 213 is coded with a circle 226 from the tool feature 225, indicating the sub-file 213 is classified as pending, the sub-file 215 is coded with a triangle 228 from the tool feature 225, indicating that the sub-file 215 is moving forward; and the sub-file 217 is coded with a square 230 from the tool feature 225, indicating that the sub-file is inactive. In accordance with further embodiments of the invention, the time-line, electronic communications data and or sub-files 211 are coded for a metric that is indicated by a color, such as described below with reference to FIGS. 3A-B

FIG. 3A shows dynamic user web-page 300 with multiple displayable and interactive time-lines, 301, 303 and 305. Each of the time-lines 301, 303 and 305 represent a tread of communications data transmitted between two entities from multiple content sources and displayed chronologically, such as described above. The communications data are organized into user accessible sub-files 321, 323 and 325 for communications data transmitted on any given day. The sub-files 321, 323 and 325 preferably have a numeric that indicated the number of communications data transmitted or files transmitted on the day corresponding to the sub-file.

The dynamic user web-page 300 preferably includes a tool 350 feature, such as shown in FIG. 3B. The tool allows a user to code and organize electronic communications data or sub-files from time-lines 301, 303 and 305 into a folder based on a metric. In this example, a tool feature 350 allows a user to code each of the sub-files 321, 323 and 325 by a color. The color is used to code sub-files for a level of perceived success. For example green codes for successful, yellow codes for pending and red codes for inactive. It will be clear to one skilled in the art that the time-lines 301, 303 and 305, sub-files 321, 323 and 325 and the electronic communications data or files can all be coded with any number of different metrics. The tool feature 350, also allows the user to generate one or more folders with sub-files 321, 323 and 325, electronic communications data or files organize according to the assigned metric.

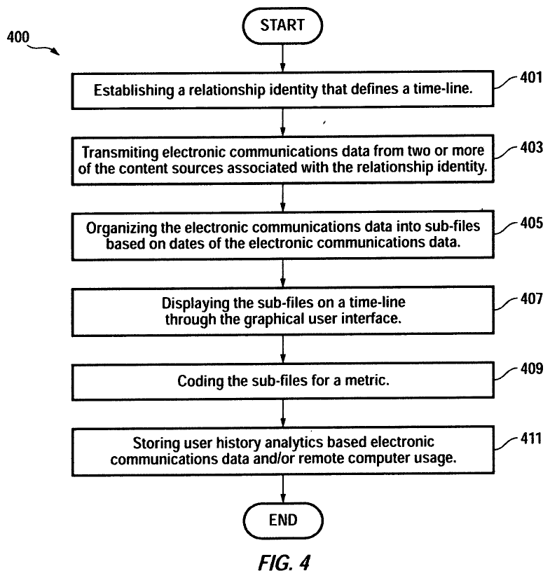

FIG. 4 shows a block-flow diagram 400 outlining steps of a method for managing transactions from multiple content sources through a graphical user interface, such as described above. In operation, a user will generally log into the server 105 (FIG. 1) that runs the application software that interfaces with an electronic communications application, such as e-mail. The user will then establish an account and down-load all of the necessary software and/or tool features required to operate the account for a remote computer. While it is preferably that the computer implemented system of the present invention operates in a cloud-based network environment, it will be clear to one skilled in the art the system of the resent invention can also be configured to be hosted and operated from the desk-top of the user's computer.

Regardless of how the user account is established or where the application software is operating, in the step 401 a user establishes a relationship identity that defines the time-line. The relationship identity is typically between the user and another entity. However, the entities in accordance with alternative embodiments of the invention are external entities, wherein the user is acting as an authorized administrator or manager of the relationship. After the user establishes a relationship identity in the step 401, in the step 403 any number of electronic communications data are transmitted (sent or received) through the account. The electronic communications data transmissions are from any number of content sources (users) associated with the relationship identity. After the communications data are transmitted in the step 403, in the step 405 the electronic communications data are organized into sub-files based on dates of the electronic communications data were transmitted. Preferably the application software of the computer implemented system automatically organizes the electronic communications data into sub-file based on a tag assigned each of the content sources (users) that are associated with the relationship identity. After the electronic communications data are organized into sub-files in the step 405, in the step 407, the sub-files are displayed chronologically on a time-line for each relationship identity, as describe above. After the sub-files are created in the step 405 and displayed in the step 407, the user can code the sub-files with any number of different metrics using tool features, such as described above. Throughout the method for managing transactions from multiple content sources, the application software can be configured to collect and store user history analytics based electronic communications data and/or remote computer usage.

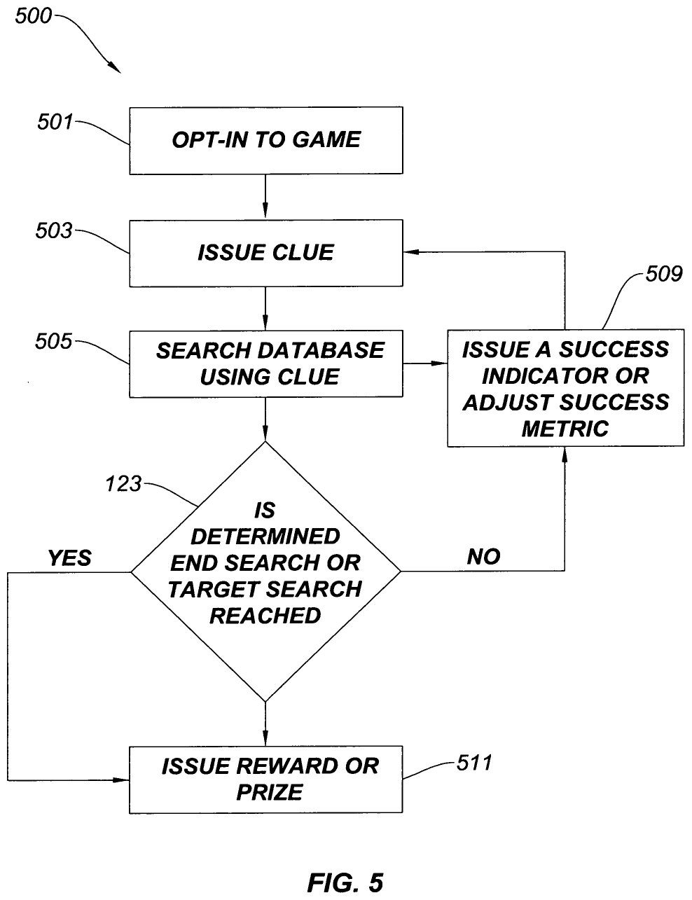

FIG. 5 shows a block-flow diagram 500 outlining steps of a method for searching web-based content data using gaming, in accordance with the embodiments of the invention. In accordance with the method, web-based content data is searched or obtained to achieve a target search. In the step 501 a user opts-in to a game and in the step 503 is issued or receives a searching clue.

Then the user then searches a data base or content data over the internet using the clue as one of the search terms. A gaming program then determines if a target search has been reached by the user in the step 507. If, in the step 507, the gaming program determines that the target search has not been reached by the user, steps 503 and 505 are repeated until the gaming program determines that the target search has been reached by the user. Once it is determined by the gaming program that the target search has been reached by the user in the step 507, then in the step 511 the gaming program issues an electronic reward, prize or coupon that can be used to purchase a product, un-lock a data base and/or can be collected and/or saved for future use.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A method for searching web-based content data to obtain a target search result
a) opt-in to game and receive a searching clue:
b) search the content data over the internet using the clue to construct search terms;
c) receive an indicator to indicate progress toward obtaining the target search result;
d) repeating steps a), b) and c) until the target search result is achieve; and
e) issuing a prize when the target search result is achieve
